(19) United States
(12) Patent Application Publication
(10) Pub. No.: US 2010/0262851 A1
(43) Pub. Date: Oct. 14, 2010

(54) NETWORK APPARATUS WITH POWER SAVING CAPABILITY AND POWER SAVING METHOD APPLIED TO NETWORK MODULE

(76) Inventor: Shang-Chih Chien, Hsinchu City (TW)

Correspondence Address: NORTH AMERICA INTELLECTUAL PROPERTY CORPORATION, P.O. BOX 506, MERRIFIELD, VA, 22116, US

(21) Appl. No.: 12/612,634

(22) Filed: Nov. 4, 2009

(30) Foreign Application Priority Data
Apr. 13, 2009 (TW) 098112176

(51) Int. Cl. G06F 1/32

(52) U.S. Cl. 713/320

(57) ABSTRACT

A network apparatus with power saving capability includes a network block, a cable-connection status detection circuit and a control circuit. The network block is used for providing a network communication function. The cable-connection status detection circuit is used for detecting the cable-connection status between the network block and the link partner to generate a detecting result. The control circuit is coupled between the network block and the cable-connection status detection circuit, and implemented for controlling the network block to switch between a first operation mode and a second operation mode according to the detecting result. The power consumption of the network block operating in the first operation mode is higher than the power consumption of the network block operating in the second operation mode.

### BACKGROUND OF THE INVENTION

1. Field of the Invention

The present invention relates to a network apparatus and a method thereof, and more particularly, to a network apparatus with power saving capability and a related method.

2. Description of the Prior Art

In a high-speed network system, such as a 1 Gbase-T/10 Gbase-T Ethernet system, the power consumption of the network system increases if its circuits operate frequently. The traditional network system must keep sending out a fixed idle pattern to maintain a connection when in the link state, even if there is no packet waiting to be transmitted. In order to let the remote network device identify the idle pattern, this idle pattern must conform to an Ethernet standard idle signal defined by IEEE standards. At this time, the power consumption of the network system is slightly lower than the power consumption in the normal state (i.e. transmitting packets). When the network system is in the link state, the power-saving mechanism focused on the physical layer can save power only by lowering speed or by lowering the transmitting capacity of the transmitter or the receiving capacity of the receiver.

However, in a prior art implementation, when the network system is in the non-link state, the network system will attempt to connect to a link partner, and keep transmitting the auto-negotiation request message to the link partner. The power-saving effect of such a mechanism is not good enough due to all of the circuits in the network system being in the power-on state. Therefore, how to decrease the power consumption of the network system in the non-link state has become an important topic for a designer in the field.

### SUMMARY OF THE INVENTION

Therefore, one of the objectives of the present invention is to provide a network apparatus with power saving capability and a related method, to solve the above-mentioned problem.

According to one embodiment of the present invention, a network apparatus with power saving capability is disclosed. The network apparatus includes a network block, a cable-connection status detection circuit and a control circuit. The network block is used for providing a network communication function. The cable-connection status detection circuit is used for detecting a cable-connection status between the network block and the link partner to generate a detecting result, wherein the cable-connection status detection circuit includes: a pulse signal generator, coupled to a network connecting port, for outputting at least a test pulse signal via the network connecting port; and a detector, coupled to the network connecting port, for detecting if the network connecting port receives a reflection pulse signal corresponding to the test pulse signal to generate the detecting result. The control circuit is coupled between the network block and the cable-connection status detection circuit, and implemented for controlling the network block to switch between a first operation mode and a second operation mode according to the detecting result, wherein the power consumption of the network block operating in the first operation mode is higher than the power consumption of the network block operating the second operation mode.

According to another embodiment of the present invention, a power saving method employed in a network apparatus is disclosed. The power saving method includes: outputting at least a test pulse signal via a network connecting port of a network block; detecting if the network connecting port receives a reflection pulse signal corresponding to the test pulse signal to generate a detecting result; controlling the network block to switch between a first operation mode and a second operation mode according to the detecting result, wherein the power consumption of the network block operating in the first operation mode is higher than the power consumption of the network block operating in the second operation mode.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIG. 1 is a diagram illustrating a network apparatus according to an exemplary embodiment of the present invention.

FIG. 2 is a diagram illustrating the network apparatus shown in FIG. 2 connected to a link partner via a network cable.

FIG. 3 is a diagram illustrating the network apparatus shown in FIG. 2 not connected to any link partner via the network cable.

FIG. 4 is a flowchart illustrating a method employed for controlling the network block shown in FIG. 1 according to an exemplary embodiment of the present invention.

### DETAILED DESCRIPTION

Certain terms are used throughout the description and following claims to refer to particular components. As one skilled in the art will appreciate, electronic equipment manufacturers may refer to a component by different names. This document does not intend to distinguish between components that differ in name but not function. In the following description and in the claims, the terms “include” and “comprise” are used in an open-ended fashion, and thus should be interpreted to mean “include, but not limited to . . . ”. Also, the term “couple” is intended to mean either an indirect or direct electrical connection. Accordingly, if one device is coupled to another device, that connection may be through a direct electrical connection, or through an indirect electrical connection via other devices and connections.

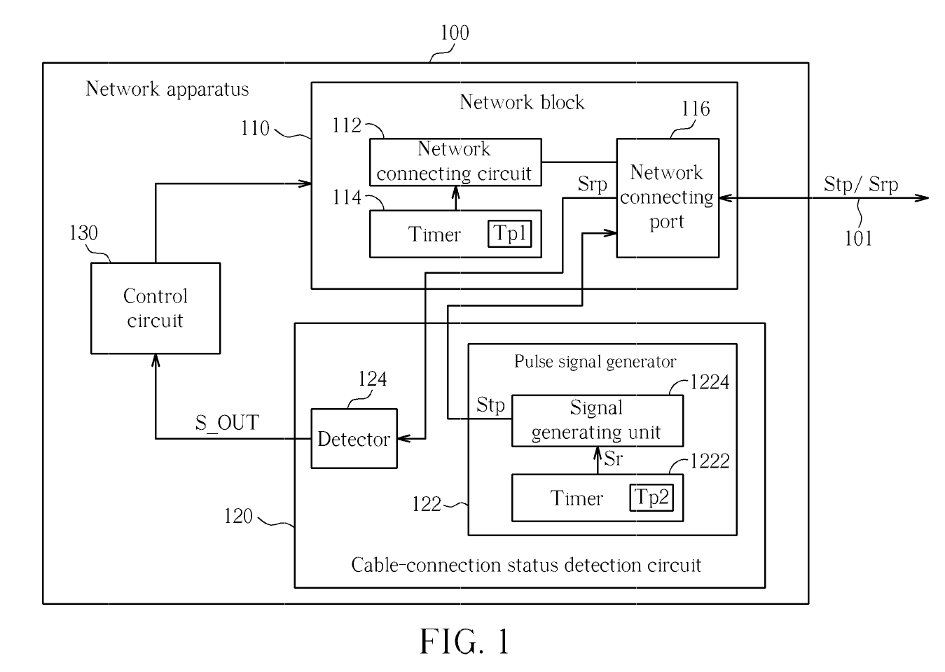

Please refer to FIG. 1. FIG. 1 is a diagram illustrating a network apparatus 100 according to an exemplary embodiment of the present invention. The network apparatus 100 includes, but is not limited to, a network block 110, a cable-connection status detection circuit 120 and a control circuit 130. The network block 110 is used for providing a network communication function to the network apparatus 100. In this embodiment, the network block 110 includes a network connecting circuit 112, a timer 114 and a network connecting port 116. The network connecting circuit 112 is used for performing an auto-negotiation mechanism to establish a connecting link between the network block 110 and a link partner (not shown in FIG. 1). The timer 114 is used for counting a predetermined time period Tp1, which controls the time period in which the network connecting circuit 112 establishes the network connecting link. The network connecting port 116 is used for connecting with the link partner physically; that is, the network connecting port 116 acts as a connecting interface between the network block 110 and a network cable 101. The cable-connection status detection circuit 120 is used for detecting the cable-connection status between the network block 110 and the link partner to generate a detecting result S_OUT. In this embodiment, the cable-connection status detection circuit 120 includes a pulse signal generator 122 and a detector 124, wherein the pulse signal generator 122 is coupled to the network connecting port 116 of the network block 110, for outputting at least a test pulse signal Stp via the network connecting port 116, and the detector 124 is also coupled to the network connecting port 116, for detecting if the network connecting port 116 receives a reflection pulse signal Srp corresponding to the test pulse signal Stp to generate the detecting result S_OUT. As shown in FIG. 1, the pulse signal generator 122 includes a timer 1222 and a signal generating unit 1224. The timer 1222 is used for generating a trigger signal Sr after each predetermined time period Tp2. The signal generating unit 1224 is coupled to the timer 1222, for generating the test pulse signal Stp after receiving the trigger signal Sr. In other words, the signal generating unit 1224 will generate one trigger signal Sr after each predetermined time period Tp2 during the operation of detecting the cable-connection status of the link partner. The control circuit 130 is coupled between the network block 110 and the cable-connection status detection circuit 120, and implemented for controlling the network block 110 to switch between a first operation mode and a second operation mode according to the detecting result S_OUT, wherein the power consumption of the network block 110 operating in the first operation mode is higher than the power consumption of the network block 110 operating in the second operation mode. For example, the first operation mode is a normal mode; therefore, all of the units of the network block 110 will be enabled to provide the complete functionality of the network apparatus. The second operation mode is a power saving mode; therefore, all or part of the units of the network block 110 will not be enabled, thereby decreasing the power consumption of the network apparatus sufficiently. Please note that the above-mentioned embodiment is merely for illustration, and should not be considered as a limitation to the scope of the present invention. That is, the first operation mode and the second operation mode can have other definitions as long as the power consumption of the network block 110 operating in the first operation mode is higher than the power consumption of the network block 110 operating in the second operation mode.

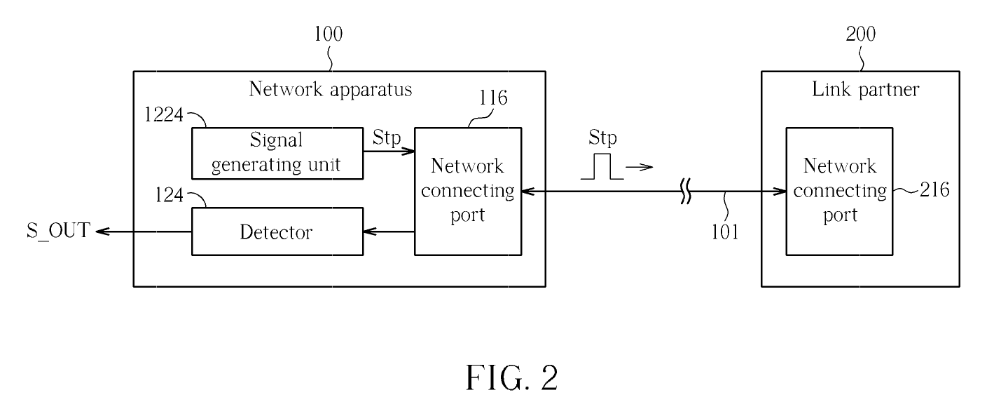

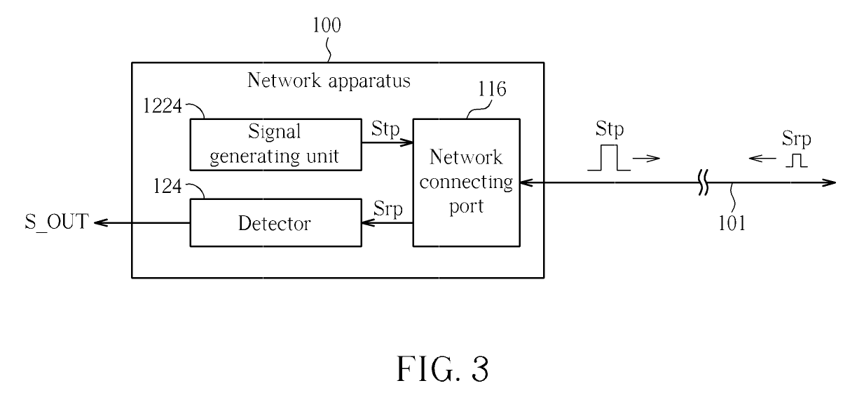

Please refer to FIG. 1 in conjunction with FIG. 2 and FIG. 3. FIG. 2 is a diagram illustrating the network apparatus 100 shown in FIG. 2 connected to a link partner 200 via a network cable 101. FIG. 3 is a diagram illustrating the network apparatus 100 shown in FIG. 2 not connected to any link partner via the network cable 101. When the functionality of detecting the cable-connection status of the link partner is activated, the pulse signal generator 122 of the cable-connection status detection circuit 120 in the network apparatus 100 outputs the test pulse signal Stp after each predetermined time period Tp2 via the network connecting port 116. Therefore, when the network apparatus 100 is not connected to any link partner, as shown in FIG. 3, the far end (i.e. the end used for connecting the link partner) of the network cable 101 will generate a reflection pulse signal Srp corresponding to the test pulse signal Stp due to the impedance mismatch between the two ends of the network cable 101. At this time, the detector 124 will receive the reflection pulse signal Srp via the network connecting port 116, thereby determining that one end of the network cable 101 is connected to the network apparatus 100, and the other end of the network cable 101 is not connected to any link partner. When the two ends of the network cable 101 are connected to the network connecting port 116 of the network apparatus 100 and a network connecting port 216 of the link partner 200, respectively (as shown in FIG. 2), the far end (i.e. the end used for connecting the link partner) of the network cable 101 will not generate the reflection pulse signal Srp corresponding to the test pulse signal Stp due to the impedance match between the two ends of the network cable 101. At this time, the detector 124 will not receive the reflection pulse signal Srp via the network connecting port 116, thereby determining that the network apparatus 100 is connected to the link partner 200 via the network cable 101. In short, the present invention generates the corresponding detecting result S_OUT according to whether the reflection pulse signal Srp is received by the detector 124 (e.g., the detector 124 sets the detecting result S_OUT corresponding to a first logic value when receiving the reflection pulse signal Srp, and sets the detecting result S_OUT corresponding to a second logic value when not receiving the reflection pulse signal Srp), thus, the following circuit (i.e. the control circuit 130) can determine whether the network apparatus 100 is connected to any link partner according to the detecting result S_OUT.

Furthermore, when the connecting link between the network block 110 and the link partner 200 is lost (i.e. there is a link lost between the network block 110 and the link partner 200), the network block 110 activates the network connecting circuit 112 and the timer 114; then, if the network block 110 fails to establish the connecting link with the link partner 200 during the predetermined time period Tp1, the control circuit 130 controls the network block 110 to switch from the first operation mode (e.g. the normal mode) to the second operation mode (e.g. the power saving mode), and enables the cable-connection status detection circuit 120 accordingly. At this time, the pulse signal generator 122 of the cable-connection status detection circuit 120 outputs the test pulse signal Stp after each predetermined time period Tp2 via the network connecting port 116. The detector 124 detects whether the network connecting port 116 receives the reflection pulse signal Srp corresponding to the test pulse signal Stp after the pulse signal generator 122 outputs the test pulse signal Stp to generate the detecting result S_OUT. If the detecting result S_OUT indicates that the detector 124 receives the reflection pulse signal Srp corresponding to the test pulse signal Stp, meaning that the network apparatus 100 is not connected to any link partner yet, the network block 110 keeps operating in the second operation mode. However, if the detecting result S_OUT indicates that the detector 124 does not receive the reflection pulse signal Srp corresponding to the test pulse signal Stp, the control circuit 130 controls the network block 110 to switch from the second operation mode to the first operation mode, disables the cable-connection status detection circuit 120, and activates the network connecting circuit 112 and the timer 114 at the same time. The network connecting circuit 112 will attempt to connect to the link partner. Then, when the network block 110 fails to establish the connecting link with the link partner during the predetermined time period Tp1, the control circuit 130 controls the network block 110 to switch from the first operation mode to the second operation mode again, and enables the cable-connection status detection circuit 120. The above-mentioned operating steps will be repeated until the network block 110 establishes the connecting link with the link partner (e.g. the link partner 200 shown in FIG. 2) successfully.

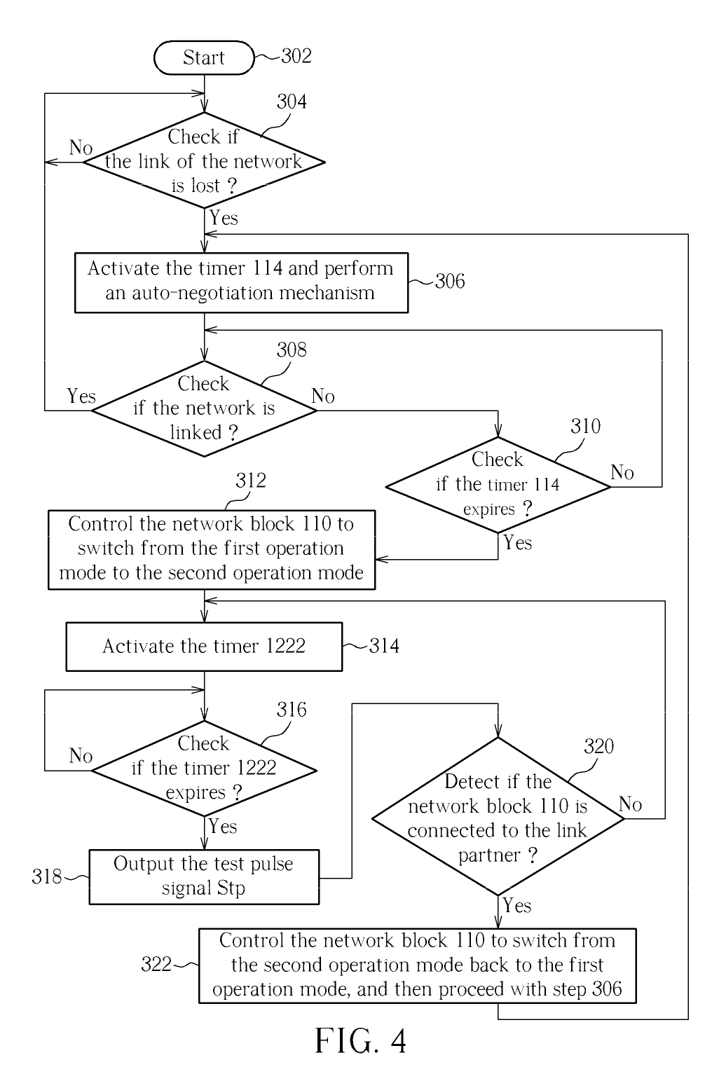

Please refer to FIG. 4. FIG. 4 is a flowchart illustrating a method employed for controlling the network block 110 shown in FIG. 1 according to an exemplary embodiment of the present invention. Please note that, provided substantially the same result is achieved, the steps of the flow shown in FIG. 4 need not be in the exact order shown and need not be contiguous; that is, other steps can be intermediate. The exemplary method includes the following steps:

Step 302: Start.

Step 304: Check if the link of the network is lost. If yes, go to step 306.

Step 306: Activate the timer 114 and perform an auto-negotiation mechanism.

Step 308: Check if the network is linked. If yes, go back to step 304; otherwise, go to step 310.

Step 310: Check if the timer 114 expires. If yes, go to step 312; otherwise, go back to step 308.

Step 312: Control the network block 110 to switch from the first operation mode to the second operation mode.

Step 314: Activate the timer 1222.

Step 316: Check if the timer 1222 expires. If yes, go to step 318; otherwise, execute to step 316 again.

Step 318: Output the test pulse signal Stp.

Step 320: Detect if the network block 110 is connected to the link partner. If yes, go to step 322; otherwise, go back to step 314.

Step 322: Control the network block 110 to switch from the second operation mode back to the first operation mode, and then proceed with step 306.

Step 318 outputs the test pulse signal Stp via the network connecting port 116 of the network block 110. Step 320 detects if the network connecting port 116 receives the reflection pulse signal Srp corresponding to the test pulse signal Stp to generate the detecting result S_OUT, and controls the network block 110 to switch between the first operation mode and the second operation mode according to the detecting result S_OUT, wherein the power consumption of the network block 110 operating in the first operation mode is higher than the power consumption of the network block 110 operating in the second operation mode. As a person skilled in the art can readily understand the related operations of the steps shown in FIG. 4 after reading the above paragraphs directed to the network apparatus 100 shown in FIG. 1, further description is omitted here for brevity.

In summary, the present invention provides a network apparatus with power saving capability, and a method thereof. By controlling the network block to switch between the first operation mode and the second operation mode, when the network block is not connected to any link partner, the power consumption of the network apparatus can be effectively decreased, thereby achieving the power saving purpose.

Those skilled in the art will readily observe that numerous modifications and alterations of the device and method may be made while retaining the teachings of the invention.

What is claimed is:

1. A network apparatus with power saving capability, comprising:
a network block, for providing a network communication function;
a cable-connection status detection circuit, for detecting a cable-connection status between the network block and a link partner to generate a detecting result, the cable-connection status detection circuit comprising:
a pulse signal generator, coupled to a network connecting port of the network block, for outputting at least a test pulse signal via the network connecting port; and
a detector, coupled to the network connecting port, for detecting if the network connecting port receives a reflection pulse signal corresponding to the test pulse signal to generate the detecting result; and
a control circuit, coupled between the network block and the cable-connection status detection circuit, for controlling the network block to switch between a first operation mode and a second operation mode according to the detecting result, wherein the power consumption of the network block operating in the first operation mode is higher than the power consumption of the network block operating in the second operation mode.

2. The network apparatus of claim 1, wherein the pulse signal generator comprises:
a timer, for generating a trigger signal after each predetermined time period; and
a signal generating unit, coupled to the timer, for generating a test pulse signal upon receiving the trigger signal.

3. The network apparatus of claim 1, wherein the control circuit enables the cable-connection status detection circuit when the network block operates in the second operation mode; when the detecting result indicates that the detector does not receive the reflection pulse signal corresponding to the test pulse signal, the control circuit controls the network block to switch from the second operation mode to the first operation mode, and disables the cable-connection status detection circuit; and when the detecting result indicates that the detector receives the reflection pulse signal corresponding to the test pulse signal, the network block continues operating in the second operation mode.

4. The network apparatus of claim 3, wherein the network block comprises:
a network connecting circuit, for performing an auto-negotiation mechanism to establish a connecting link between the network block and the link partner; and
a timer, for counting a predetermined time period;
wherein when the connecting link between the network block and the link partner is lost, the network block activates the network connecting circuit and the timer, and when the network block fails to establish the connecting link with the link partner successfully during the predetermined time period, the control circuit controls the network block to switch from the first operation mode to the second operation mode, and enables the cable-connection status detection circuit.

5. The network apparatus of claim 3, wherein the network block comprises:
a network connecting circuit, for performing an auto-negotiation mechanism to establish a connecting link between the network block and the link partner; and
a timer, for counting a predetermined time period;
wherein when the detecting result indicates that the detector does not receive the reflection pulse signal corresponding to the test pulse signal, the control circuit controls the network block to switch from the second operation mode to the first operation mode to activate the network connecting circuit and the timer, and when the network block fails to establish the connecting link with the link partner successfully during the predetermined time period, the control circuit controls the network block to switch from the first operation mode to the second operation mode, and enables the cable-connection status detection circuit.

6. A power saving method employed in a network apparatus, comprising:
detecting a cable-connection status between the network block and a link partner to generate a detecting result, comprising:
outputting at least a test pulse signal via a network connecting port of the network block; and
detecting if the network connecting port receives a reflection pulse signal corresponding to the test pulse signal to generate the detecting result; and
controlling the network block to switch between a first operation mode and a second operation mode according to the detecting result, wherein the power consumption of the network block operating in the first operation mode is higher than the power consumption of the network block operating in the second operation mode.

7. The power saving method of claim 6, wherein the step of outputting at least the test pulse signal via the network connecting port of the network block comprises:
outputting one test pulse signal after each predetermined time period.

8. The power saving method of claim 6, wherein the step of detecting the cable-connection status between the network block and the link partner is performed when the network block operates in the second operation mode; and the step of controlling the network block to switch between the first operation mode and the second operation mode according to the detecting result comprises:
when the detecting result indicates that the detector does not receive the reflection pulse signal corresponding to the test pulse signal, controlling the network block to switch from the second operation mode to the first operation mode and stopping performing the step of detecting the cable-connection status between the network block and the link partner; and
when the detecting result indicates that the detector receives the reflection pulse signal corresponding to the test pulse signal, keeping the network block to operate in the second operation mode.

9. The power saving method of claim 8, further comprising:
when the connecting link between the network block and the link partner is lost, controlling the network block to perform an auto-negotiation mechanism to establish a connecting link between the network block and the link partner; and
when the network block fails to establish the connecting link with the link partner successfully during the predetermined time period, controlling the network block to switch from the first operation mode to the second operation mode and performing the step of detecting the cable-connection status between the network block and the link partner.

10. The power saving method of claim 8, further comprising:
when the detecting result indicates that the detector does not receive the reflection pulse signal corresponding to the test pulse signal, controlling the network block to perform an auto-negotiation mechanism to establish a connecting link between the network block and the link partner; and
when the network block fails to establish the connecting link with the link partner successfully during the predetermined time period, controlling the network block to switch from the first operation mode to the second operation mode and performing the step of detecting the cable-connection status between the network block and the link partner.
